(19) United States
(12) Patent Application Publication
(10) Pub. No.: US 2006/0097652 A1
(43) Pub. Date: May 11, 2006

(54) Circuit and method for providing power to a load, especially a high-intensity discharge lamp

(75) Inventors: Dolf Henricus Jozef Van Casteren, Eindhoven (NL); Ronald Hans Van Der Voort, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/541,987

(22) PCT Filed: Dec. 5, 2003
(86) PCT No.: PCT/IB03/05850

§ 371 Date: Jul. 11, 2005

(30) Foreign Application Priority Data
Jan. 14, 2003 (EP) 03075108.5

(51) Int. Cl. H05B 39/04; H05B 41/36

(52) U.S. Cl. 315/209 R

(57) ABSTRACT

Circuit for providing power to a load with a pre-determined specification, comprising:—a transformer having a primary winding and a secondary winding, said secondary winding being part of a resonant circuit;—first and second load connection nodes for coupling of the load in series to the secondary winding;—a switch coupled in series to the primary winding, an on and off-time of the switch being controllable by a control element, for generating a voltage pulse over the primary winding; wherein a diode is coupled in parallel to the primary winding for demagnetizing the transformer during the off-time of the switch, the on and off-time of the switch being predetermined. The diode provides a free-running path to demagnetize the transformer if the switch is off. To prevent saturation of the core of the transformer, a subsequent voltage pulse is only applied to the circuit if the free-running current through the diode has become substantially zero.

The present invention relates to a circuit for providing power to a load with a pre-determined specification, comprising:
a transformer having a primary winding and a secondary winding, said secondary winding being part of a resonant circuit;
first and second load connection nodes for coupling of the load in series to the secondary winding;
a switch coupled in series to the primary winding, an on and off-time of the switch being controllable by a control element, for generating a voltage pulse over the primary winding.

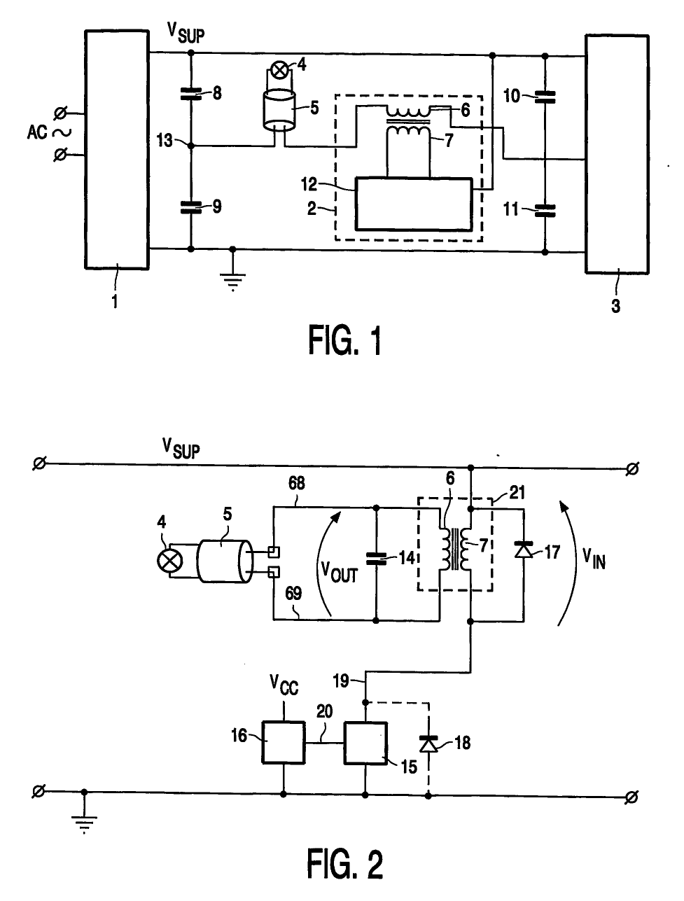

U.S. Pat. No. 6,144,171 discloses an ignition circuit for igniting a high-intensity discharge lamp. The circuit comprises a transformer having a primary winding and a secondary winding, the transformer being rated to avoid saturation. A capacitor is coupled in parallel to the secondary winding to form a resonant circuit. A switching element coupled in series to the primary windings is controllable by a control element. The on and off switching of the switch takes place when a certain current (current through SIDAC in FIG. 1) or voltage (drain-source voltage in FIG. 7) is reached at some point in the circuit, forming a closed loop system.

This circuit has the drawback that the control element is complex due to the closed loop system.

The general object of the invention is to provide a circuit for providing power to a load with a predetermined specification, such as an HID lamp, with a limited number of components and a low dissipation.

This object is achieved by coupling a diode in parallel to the primary winding for demagnetizing the transformer during the off-time of the switch, the on and off-time of the switch being predetermined.

The diode provides a free-running path to demagnetize the transformer if the switch is off. To prevent saturation of the core of the transformer, a subsequent voltage pulse can only be applied to the circuit if the free-running current through the diode has become substantially zero. Based on these considerations, the off-time necessary to fulfill these conditions can be calculated for the circuit, so that the switch can be controlled with a predetermined on and off-time. This means that no feedback is necessary, offering a simple open-loop system, with a limited number of components.

It is further noted that the oscillation which starts when the switch is closed is not interrupted when the switch is opened, and continues until the transformer is at least partly demagnetized.

According to a first embodiment of the invention a capacitor is added in parallel to the secondary winding for adjusting the resonance period of the resonant circuit.

The parasitic capacitances, including the capacitance of the cable furnishing power to the lamp, cause a capacitance at the secondary winding, so that a resonant circuit is formed. The resonance circuit being typically determined by the stray inductance of the secondary side and the value of this capacitance. If one wishes to alter the value of the resonant frequency, one possibility consists of adding an external capacitance in parallel to the secondary winding.

According to a preferred embodiment of the invention, the transformer has a couple factor which is smaller than one.

This is possible because of the presence of the free-running diode and has advantages for the short-circuit current, as will be further explained below.

According to a further aspect of the invention a control element is added to control the switch, wherein the control element is selected to cause the on-time of the switch to be at least half of the resonance frequency.

In this way the maximum output voltage is reached independently of the value of the output capacitor.

According to yet another aspect of the invention the control element is selected to cause the off-time of the switch to be sufficient for reducing the diode current to substantially zero during demagnetization of the transformer.

In order to reduce the required off-time, a resistor can be connected in series to the diode to reduce the necessary switch off-time.

When the switch is opened, the current commutates from the switch to the diode. This current is substantially given by the sum of the current through the primary inductor decreasing in accordance with a negative e-power and the oscillating current through the secondary winding reduced to the primary winding. The time constant of the e-power (T_{C}=L/R, where L is the inductance of the primary winding of the transformer, and R the resistance in the diode branch) can be altered by adding a resistor R_{S} in series to the diode, so that the total resistance is given by R=R_{diode}+R_{S}, where R_{diode} is the internal resistance of the diode.

The invention further relates to a method for providing power to a load, comprising the steps of:
applying a number of voltage pulses to a primary winding of a transformer so as to produce each time a high voltage pulse on the secondary winding thereof, which pulse is shaped by the transformer inductances and capacitances at the secondary winding to create a load pulse;
applying the load pulse to the load.

The method is distinguished in that between each application of a voltage pulse a current path for the primary current is provided so that the transformer is demagnetized and saturation of the transformer is prevented.

This current path allows the current to become substantially zero before a subsequent voltage pulse is applied.

According to a first aspect of the method of the invention, the load can be a high-intensity discharge lamp, wherein a first series of lamp pulses is applied to ignite said lamp, whereupon a second series of pulses is applied to operate the lamp during the electrode heating phase.

The first series of lamp pulses typically have a voltage level between 3 and 4 kV, while the lamp voltage during the warm-up phase of the electrode can vary, typically between a very low voltage and 250 V. In order to deliver enough energy during the warm-up phase of the electrodes, it can be advantageous to use a circuit with a low off-time, which means that the current through the current path at the primary side must to decrease sufficiently rapidly. As explained above, a resistor can be added in series to said diode to obtain such an effect.

The invention also relates to a method for optimizing the parameters of the circuit according to the invention, wherein
the maximum oscillation period of the resonant circuit is determined on the basis of the maximum value of the capacitance at the secondary side when a load is connected;
the on-time of the switch is chosen to be higher than half of said oscillation period.

The lowest oscillating frequency of the output voltage T_{O,MIN} is determined by the stray inductance L_{2×} and the maximum specified output capacitance C_{OUT,MAX}, and is given by
ω_{O,MIN}=1/≦\sqrt{L_{2×}·C_{OUT,MAX}}.
The duration of the voltage pulse T_{ON} has to be at least half of the highest oscillation period, being T_{O}=2B/T_{O,MIN}, to reach the maximum output voltage independently of the value of the output capacitor.

According to a further aspect of the method for optimizing the parameters of the circuit, the off-time of the switch is chosen to be higher than the time necessary to reduce the current through the diode to substantially zero.

A further object of the invention is to minimize the losses in the circuit.

Thereto, according to yet a further aspect of the method of the invention for optimizing the parameters of the circuit, the mean value of the short-circuit current over the on and off time of the switch is calculated for a range of couple factors, whereupon the couple factor for which this value is minimal is selected such that the losses caused by the current through the switch and the diode are substantially minimized.

Two types of loss can be distinguished in the circuit: the conduction losses when the switch is on and the losses when the switch is turned off. Two theoretical operating situations at the output can be considered here: an open circuit (no load present) and a short-circuit situation. A short-circuit current can occur during the start-up phase of the lamp or when the output is accidentally short-circuited. In practice the short-circuit case usually forms the determining factor for the losses, and k is chosen in order to obtain a minimal short-circuit current.

These and other aspects of the present invention will become apparent from and be elucidated with reference to the illustrative embodiments described hereinafter by way of non-limiting indication and on the basis of the attached drawings, in which:

FIG. 1 is a schematic circuit diagram of a prior art ballast;

FIG. 2 is schematic circuit diagram of a first embodiment of the igniter circuit according to the invention;

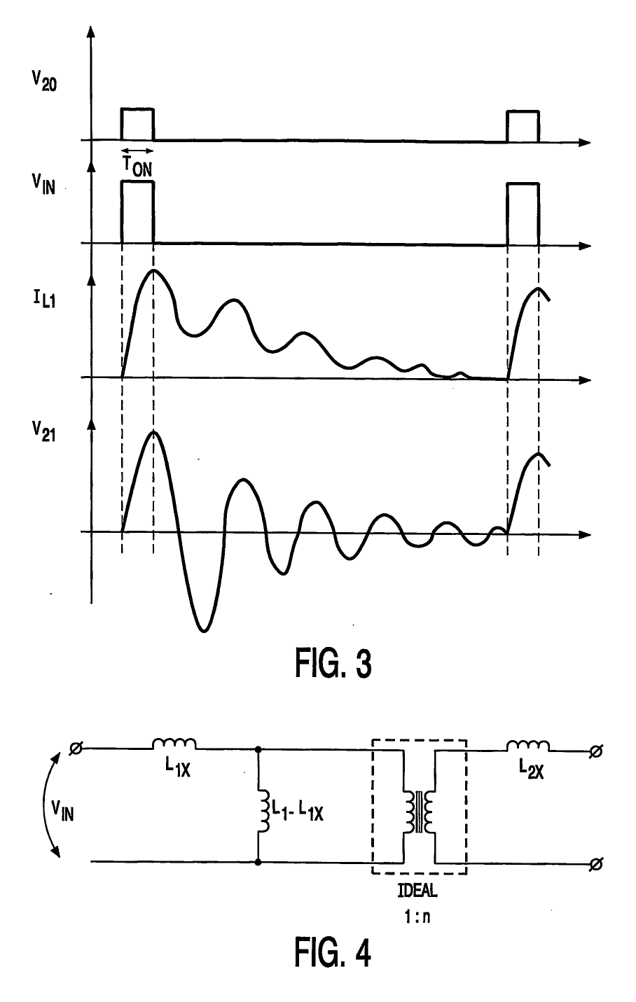

FIG. 3 represents schematically the current and/or voltage waveforms at various points of the circuit of FIG. 2;

FIG. 4 is a circuit model representing a real transformer, which will be used to analyze the power circuit of the igniter circuit of the invention;

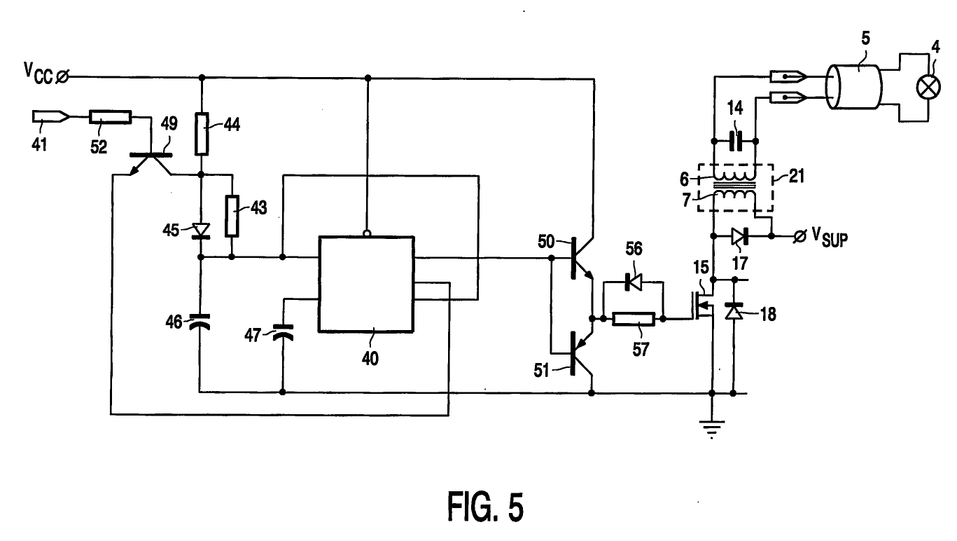

FIG. 5 is a schematic circuit diagram of a further embodiment of the igniter circuit of FIG. 2, using a specific control circuit;

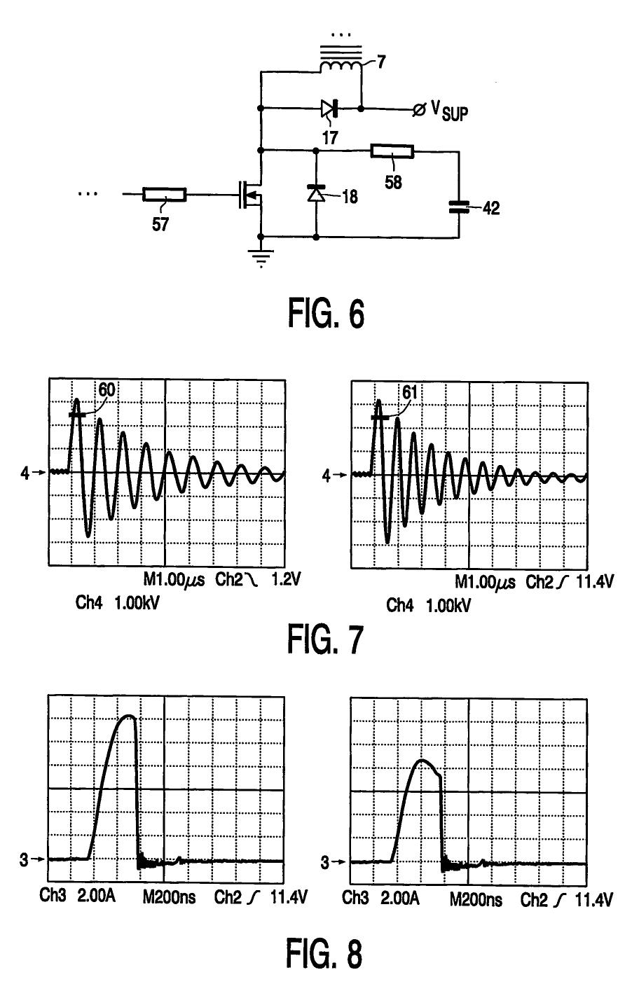

FIG. 6 shows an improved version of the embodiment of FIG. 2;

FIG. 7 is a waveform diagram showing the ignition voltage in 21 for respectively (a) C_{OUT}=100 pF, and (b) C_{OUT}=22 pF, during operation of the ignition circuit of FIG. 5;

FIG. 8 is a waveform diagram showing the current through the IGBT for respectively (a) C_{OUT}=100 pF, and (b) C_{OUT}=22 pF, during operation of the ignition circuit of FIG. 5;

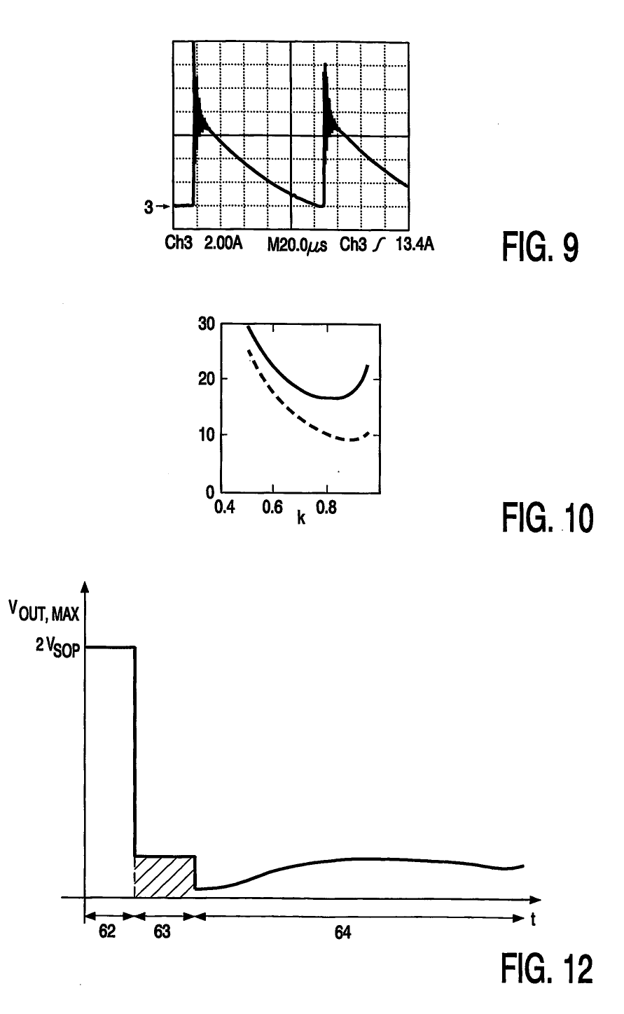

FIG. 9 is a waveform diagram showing the current through the diode 17 for C_{OUT}=100 pF, during operation of the ignition circuit of FIG. 5;

FIG. 10 shows a plot of the short circuit current in an igniter circuit according to the invention as functions of the couple factor of the transformer;

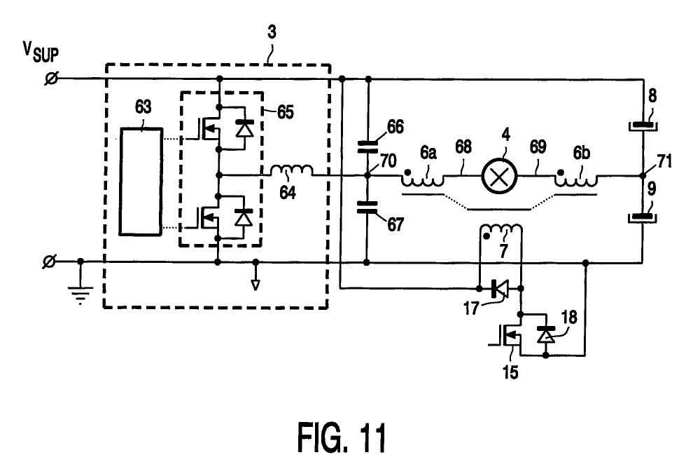

FIG. 11 is a schematic circuit diagram of a symmetrical embodiment of the igniter circuit of the invention;

FIG. 12 represents schematically the output voltage V_{OUT} at the secondary side during the ignition phase and during the take-over or warm-up phase of the lamp.

FIG. 1 shows a ballast circuit which is suitable for both igniting and operating an HID lamp 4. A first circuitry block 1, typically comprising a rectifier and an up-converter, converts an AC input voltage into a high DC output voltage V_{SUP}. This high DC voltage is used as the supply voltage V_{SUP} for respectively the igniter circuit 2 and the forward commutating stage 3 fulfilling the function of a down-convertor and a commutator in one integrated stage.

Capacitor 8 and 9 are buffer capacitors with the function of voltage divider, so that the voltage in 13 is substantially equal to V_{SUP}/2. This connection point 13 is connected to one winding of the lamp 4 via a cable 5.

The igniter circuit 2, intended to generate ignition voltage pulses for igniting the lamp 4, includes two coupled inductors, being a secondary winding 6 and a primary winding 7 connected to a primary circuit 12. The primary circuit 12 causes a current peak in the primary winding 7, in order to generate a high-voltage pulse at the secondary winding 6.

A first embodiment of an igniter circuit according to the invention is shown in FIG. 2. One end of the primary winding is connected to the supply voltage V_{SUP} while the other end is connected to a switching device 15. This device 15 is preferably an insulated gate bipolar transistor (IGBT) or a high-voltage field effect transistor (FET), but can also be for example a bipolar transistor. This switching device 15 is opened and closed by command of a control circuit 16.

Diode 18 represents the internal diode of the switching device 15, and is not present if the switch 15 is for example an IGBT. A second diode 17 is mounted in parallel with the primary windings 7, its flow direction being from the switch towards the supply voltage. When the switch 15 is opened, the current commutates from the switching device 15 to the diode 17. Or, in other words, the diode 17 provides a free-running path for the current through the stray inductance of the transformer and ultimately clamps the voltage in 19 to the supply voltage.

The operating principle of the circuit will now be described in greater detail with reference to FIG. 3. When a voltage pulse with a predetermined width T_{ON} is applied to the input terminal 20 of the electronic switching device 15, i.e. the gate in the case of an IGBT, the switching device 15 is turned on, as indicated with the reference 30 in FIG. 3. This causes a substantially instant voltage decrease at the drain/collector 19 of the switching device 15, so that the voltage V_{IN} across the primary winding becomes substantially equal to V_{SUP}, as indicated with reference numeral 31. An increasing current now flows through the primary winding 7 into the switching device 15 (into the collector in the case of an IGBT, and into the drain in the case of a power MOSFET), as shown in 32.

The voltage step 31 applied to the primary winding 7 further induces an oscillation in the resonant circuit formed by the output capacitor 14 and the transformer 21. The value of output capacitor 14 is the sum of all parasitic capacitances, including the capacitance of the cable 5 furnishing power to the lamp. An external capacitance may be added if one wishes to alter this value.

When the switch 15 is on, the current waveform through the primary, and indicated with 32, is the sum of a linearly increasing current through the inductor 7 and the oscillating current, reduced to the primary, through the secondary stray inductance and the output capacitor.

When the switch 15 is opened, the current commutates from the IGBT to the diode 17. The corresponding current waveform is referenced with 33, and can be observed as the sum of the current through the inductor 7 decreasing in accordance with a negative e-power and the oscillating current through the secondary winding reduced to the primary winding. The time constant of the e-power (T_{C}=L/R, where L is the inductance seen at the primary of the transformer, and R the resistance in the diode branch) can be altered by adding a resistor R_{S} in series to the diode 17, so that R=R_{diode}+R_{S}, where R_{diode} is the internal resistance of the diode 17. However, this causes extra energy to be dissipated in the resistor R_{S}. In order to minimize this current, the primary inductance should be as high as possible, which means that the couple factor of the transformer should be 1. However, as will be explained when discussing the short-circuit current, it will be observed that the couple factor needs to be lower than 1 in order to limit the short-circuit current and the losses in the circuit.

In order to explain the behavior of the circuit, we are now going to analyze the operating principles mathematically using the circuit model of FIG. 4 for the transformer 21 of FIG. 2. L₁ and L₂ are respectively the total primary and the total secondary inductance, and L_{1×} and L_{2×} represent the respective stray inductances. L_{2×} is given by L₂*(1-k²), where k is the couple factor of the transformer.

Assuming the primary stray inductance to be zero in order to simplify the calculations, the maximum voltage across the secondary V_{OUT,MAX} is given by
V_{OUT,MAX}=2·V_{IN}·n,
wherein V_{IN} is the primary voltage as indicated in FIG. 4, and n is given by

$$1 / n = \sqrt{\frac{{L}_{1}}{{L}_{2} - {L}_{2 x}}}$$

The lowest oscillating frequency of the output voltage T_{O,MIN} is determined by the stray inductance L_{2×} and the maximum specified output capacitance C_{OUT,MAX}, and is given by
ω_{O,MIN}=1/\sqrt{L_{2×}·C_{OUT,MAX}}.

The duration of the voltage pulse T_{ON} has to be at least half of the highest oscillation period, being T_{O}=2B/T_{O,MIN}, to reach the maximum output voltage independently of the value of the output capacitor. This means that, assuming the transformer inductance to be fixed, the minimum on-time T_{ON} is determined by the value of the output capacitor, which depends on the length of the cables used.

Now will be explained how the couple factor can be optimized in order to minimize the losses in the circuit. Two types of losses can be distinguished in the circuit: the conduction losses when the switch is on and the losses when the switch is turned off. Two theoretical operating situations at the output will be considered here: an open circuit (no load present) and a short-circuit situation. In practice a short-circuit current can occur during the start-up phase of the lamp or when the output is accidentally short-circuited. First an analysis of the short-circuit current is performed. When the output is short-circuited, the load at the secondary side, as seen from the primary side, is L_{2×}′=L_{2×}/n². Hence it follows that

$${V}_{IN} = ( {L}_{2 x}^{′} // {L}_{1} ) \frac{ⅆ {i}_{short}}{ⅆ t}$$

Integrating over T_{ON} gives an average value of the short-circuit current:

$${i}_{short} = \frac{{V}_{IN} \cdot {T}_{ON}}{\frac{{L}_{1} \cdot {L}_{2 x}^{′}}{{L}_{1} + {L}_{2 x}^{′}}}$$

Taking into account the dependence on k of the inductances L₁ and L_{2×}′, and the indirect dependence of T_{ON} on k, i.e. T_{ON} has to be larger than half the oscillation period:
T_{ON}≧2·π·\sqrt{L_{2×}·C_{OUT,MAX}},
k can be chosen to minimize the short-circuit current.

Using the same assumptions for the transformer model, the open-circuit current can be calculated and averaged over T_{ON}, which results in:

$${i}_{normal} = 2 \frac{{V}_{IN}}{π} \cdot \sqrt{\frac{{C}_{OUT} \cdot {n}^{2}}{{L}_{2 x}^{′}}} + {V}_{IN} \frac{{T}_{ON}}{2 \cdot {L}_{1}}$$

In FIG. 10 the short-circuit current iₛₕₒᵣₜ and the open-circuit current iₙₒᵣₘₐₗ are plotted against the couple factor k. This plot shows that a value of k of approximately 0.8 gives the lowest short-circuit current iₛₕₒᵣₜ with typical parameters.

It will be apparent that other averaging techniques can be used, but the result should be substantially the same.

A similar analysis, which will not be done here, can be repeated for the short-circuit and open-circuit current during the off-time of the switch.

A preferred embodiment of the control circuit 16 to command the switching device 15, being an HV MOSFET, is shown in FIG. 5. The MOSFET control signal is generated by a timer 40, which is connected in a manner well known to the person skilled in the art.

Suitable values for the various components of the ignition circuit designed for driving an HID lamp, typically a metal halide lamp, are as follows: inductor 6, 18: H, inductor 7, 300: H, coupling factor k, 0.8, diode 17, MUR160, timer 40, LMC555, resistor 43, 560 kΣ, resistor 44, 2.2 kΣ, zener diode 45, BAS85, capacitor 46, 220 pF, capacitor 47, 10 nF, PNPs 49 and 51, BC369, NPN 50, BC368, resistor 52, 100 kΣ, resistor 57, 33 Σ, diode 56, 1N4148.

It will be appreciated that the values given above for the various components of the circuit are merely illustrative, and that other values and designs are also suitable based on the particular criteria and preferences of the circuit designer.

In some cases it can be advantageous to shut down the igniter for a certain time period. This is for example the case when the lamp heats up but is not yet ignited. Since a warm lamp is more difficult to ignite than a cold lamp, the igniter may typically be stopped for a few minutes to allow the lamp to cool down. This can be done by connecting a second timer (not shown) to pin 41, which timer provides a burst mode in order to reduce the losses in the circuit to a minimum.

The igniter circuit can be further improved by using an RC snubber, as shown in FIG. 6, to suppress the voltage spike on the collector/drain 19 of the switching device 15 when it is switched off. The capacitor 42 and the resistor 58 are tuned to reduce the overshoot on the drain/collector 19 of the switching device 15 during switching. Typical values for the elements of the snubber circuit are: capacitor 42, 560 pF, resistor 58, 5.6Σ.

According to the American standard ANSI M98, which defines electrical data for operating a “70 W Single ended HID lamp”, the minimum pulse width should be 1: s @2.7 kV. This is not the standard used by the applicant. The proposed circuit is capable of providing 100: s/s @ 2.7 kV, i.e. when the circuit is used for 1 s, the total pulse width of the voltage supplied to the lamp at 2.7 kV should be 100: s. Typically, T_{ON} is chosen to be for example 400 ns, while the total period of the signal driving the switching device is chosen to be for example T=100: s.

FIGS. 7, 8 and 9 show a number of waveforms measured for the ignition circuit of FIG. 5 with capacitive loads of respectively 22 pF and 100 pF, and T_{ON}=400 ns. A 100 pF load is typical for a 3-metre cable to the lamp 4. In FIG. 7 the voltage in 21 is plotted against time, wherein the scale of the y axis is 1 kV/major division, while time is shown along the x-axis in 1: s/major division. The pulse width at 2.7 kV is indicated with respectively 60 and 61 for C_{OUT}=100 pF and C_{OUT}=22 pF. It can be observed that for both values of C_{OUT} the maximum output voltage V_{OUT} is almost the same.

In FIG. 8 the current through the switch is plotted against time, wherein the scale of the y axis is 2 A/major division, while time is shown along the x-axis in 200 ns/major division. Note that the surface area described by the current waveform, which is proportional to the dissipated energy, is roughly the same for the two values of the output capacitance C_{OUT}, while in conventional circuits the energy is proportional to the value of the output capacitance.

In FIG. 9 the current in the diode 17 is plotted against time, wherein the scale of the y axis is 2 A/major division, while time is shown along the x-axis in 2: s/major division. The diode current is the sum of the current through the inductor 7 decreasing in accordance with a negative e-power and the oscillating current through the secondary winding reduced to the primary winding.

FIG. 11 shows a symmetrical variant of the circuit according to the invention. The lamp is driven by a typical forward-commutating stage 3, but in principle any commutating stage can be combined with the igniter circuit shown in FIG. 11. The difference with the igniter circuit of FIG. 2 is related to the symmetrical construction of the secondary side.

A first secondary winding 6a is connected between a first lamp connection node 68 and the output node 70 of the forward-commutating stage 3. Two filter capacitors 66 and 67 that are connected between respectively the supply voltage and node 70, and between node 70 and ground, were added to filter out any high frequency components in the lamp current. A second secondary winding 6a is connected between a second lamp connection node 69 and node 71. This node is situated between two buffer capacitors 8 and 9 that are connected in series between the supply voltage V_{SUP} and the ground.

Considering the lower voltage levels with respect to earth, this symmetrical variant has certain advantages in view of the isolation requirements.

In FIG. 12 the maximum output voltage V_{OUT} is plotted against time. The circuit of the invention can be used in the following two phases of the lamp operation: the ignition phase, where the maximum output voltage is given by 2*V_{SUP}*n, being typically 3-4 kV, and the warm-up phase of the lamp electrodes, where the output voltage varies typically between a very low voltage and 200-250 V, as indicated with reference 63 in FIG. 12. The third period 64, shown in FIG. 12, represents the run-up phase and the normal operation phase, wherein power is delivered to the lamp by the forward commutating stage 3. Using the circuit of the invention during the warm-up phase of the lamp has the advantage that the open circuit voltage of the forward commutating stage can be reduced. It will be apparent that the choice of power components of the commutating-forward stage benefits from this lower supply voltage.

The invention is not limited by the above illustrated preferred embodiments, many modifications of which can be envisaged. The scope and spirit of the invention is set forth in the following claims.

1. Circuit for providing power to a load with a pre-determined specification, comprising:
a transformer having a primary winding and a secondary winding, said secondary winding being part of a resonant circuit;
first and second load connection nodes for coupling of the load in series to the secondary winding;
a switch coupled in series to the primary winding, an on and off-time of the switch being controllable by a control element, for generating a voltage pulse over the primary winding; characterized in that a diode is coupled in parallel to the primary winding for demagnetizing the transformer during the off-time of the switch, the on and off-time of the switch being predetermined.

2. Circuit according to claim 1, characterized in that a capacitor is added in parallel to the secondary winding for adjusting the resonance period of the resonant circuit.

3. Circuit according to claim 1, characterized in that the transformer has a couple factor which is smaller than one.

4. Circuit according to claim 1, wherein a control element is added to control the switch, characterized in that the control element is selected to cause the on-time of the switch to be at least half of the resonance frequency.

5. Circuit according to claim 1, wherein a control element is added to control the switch, characterized in that the control element is selected to cause the off-time of the switch to be sufficient to reduce the current in the diode to substantially zero during demagnetization of the transformer.

6. Circuit according to claim 1, characterized in that a resistor is connected in series to the diode to reduce the necessary switch off-time.

7. Method for providing power to a load, comprising the steps of:
applying a number of voltage pulses to a primary winding of a transformer so as to produce each time a high-voltage pulse on the secondary winding thereof, which pulse is shaped by the transformer inductances and capacitances at the secondary side to create a load pulse;
applying the load pulse to the load; characterized in that between every application of a voltage pulse a current path for the primary current is provided so that the transformer is demagnetized and saturation of the transformer is prevented.

8. Method according to claim 7, wherein the load is a high-intensity discharge lamp, characterized in that a first series of pulses is applied to ignite said lamp, whereupon a second series of pulses is applied to operate the lamp during the electrode heating phase of said lamp.

9. Method for optimizing the parameters of the circuit according to claim 1, characterized in that
the maximum oscillation period of the resonant circuit is determined on the basis of the maximum value of the capacitance at the secondary side when a load is connected;
the on-time of the switch is chosen to be higher that half of said oscillation period.

10. Method for optimizing the parameters of the circuit according to claim 1, characterized in that the off-time of the switch is chosen to be higher than the time necessary to reduce the current through the diode to substantially zero.

11. Method for optimizing the parameters of the circuit according to claim 1, characterized in that the mean value of the short-circuit current over the on and off-time of the switch is calculated for a range of couple factors, whereupon the couple factor for which this value is minimal is selected.
